(19) United States
(12) Patent Application Publication
(10) Pub. No.: US 2025/0350076 A1
(43) Pub. Date: Nov. 13, 2025

(54) Electrical Connection Module, Connector and Connector Assembly

(71) Applicants: TE Connectivity Solutions GmbH, Schaffhausen (CH); Tyco Electronics (Shanghai) Co., Ltd., Shanghai (CN)

(72) Inventors: Jiaoyong (Mac) Liu, Shanghai (CN); Jie (Roger) Luo, Foshan (CN); Rong (Summer) Zhang, Shenzhen (CN); Patrick Di Paola, Middletown, PA (US)

(73) Assignees: TE Connectivity Solutions GmbH, Schaffhausen (CH); Tyco Electronics (Shanghai) Co., Ltd., Shanghai (CN)

(21) Appl. No.: 19/203,801

(22) Filed: May 9, 2025

(30) Foreign Application Priority Data
May 9, 2024 (CN) 202410573743.1

(51) Int. Cl. H01R 25/14

(52) U.S. Cl. CPC H01R 25/142

(57) ABSTRACT

An electrical connection module includes a shell, a terminal, a first electrical connection member, and a second electrical connection member. The shell has a pair of side walls opposite each other in a transverse direction of the shell, a front opening and a rear opening opposite each other in a longitudinal direction of the shell, and a first spring piece and a second spring piece each formed on one side wall. The terminal has a rear end portion, is rotatably installed in the shell, and swings relative to the shell about an axis extending along a height direction of the shell. The first electrical connection member has a first plate-shaped part inserted into the rear opening and clamped between the first spring piece and one side of the rear end portion making electrical contact with the terminal. The second electrical connection member has a second plate-shaped part inserted into the rear opening and clamped between the second spring piece and the other side of the rear end portion making electrical contact with the terminal. A portion of the first electrical connection member and a portion of the second electrical connection member are located outside the shell and each electrically connect to one of a first electrical transmission component and a second electrical transmission component. A front end of the terminal extends out of the front opening and electrically contacts a mating terminal.

### CROSS-REFERENCE TO RELATED APPLICATION

This application claims the benefit of the filing date under 35 U.S.C. § 119(a)-(d) of Chinese Patent Application No. CN202410573743.1 filed on May 9, 2024.

### FIELD OF THE INVENTION

The present invention relates to a connection module and, more particularly, to an electrical connection module, a connector comprising the electrical connection module, and a connector assembly comprising the connector.

### BACKGROUND OF THE INVENTION

In the prior art, the power supply unit of a data center is electrically connected to metal bars of cabinets through connectors. In order to improve the current transmission capability of the connector, in the prior art, the terminals of the connector usually adopt multi-layer staggered overlapping terminals, that is, the terminals include multiple terminal laminations stacked on top and bottom. Each terminal lamination is not only used for transmitting current, but also has an elastic structure for providing elastic contact force, which makes the structure of the terminal lamination complex, difficult to manufacture, and can also lead to excessive insertion force when inserting the mating terminal. Usually, the insertion force of the mating terminal is proportional to a cube of the thickness of the terminal of the connector.

In the prior art, a single connection plate is usually connected to the rear end of each terminal. The terminal can be electrically connected to an electrical transmission component, such as the connection end of a bus bar or wire harness, through the single connection plate. The front end of each terminal makes electrical contact with the mating terminal. Due to the fact that there is only a single connection plate at the rear end of each terminal of the existing connector, the current carrying capacity of the connector is poor, and there are also problems with heat dissipation and temperature rise. In addition, due to the fact that there is only a single connection plate at the rear end of each terminal, the connector cannot be applied to specific situations, reducing its versatility.

### SUMMARY OF THE INVENTION

An electrical connection module includes a shell, a terminal, a first electrical connection member, and a second electrical connection member. The shell has a pair of side walls opposite each other in a transverse direction of the shell, a front opening and a rear opening opposite each other in a longitudinal direction of the shell, and a first spring piece and a second spring piece each formed on one side wall. The terminal has a rear end portion, is rotatably installed in the shell, and swings relative to the shell about an axis extending along a height direction of the shell. The first electrical connection member has a first plate-shaped part inserted into the rear opening and clamped between the first spring piece and one side of the rear end portion making electrical contact with the terminal. The second electrical connection member has a second plate-shaped part inserted into the rear opening and clamped between the second spring piece and the other side of the rear end portion making electrical contact with the terminal. A portion of the first electrical connection member and a portion of the second electrical connection member are located outside the shell and each electrically connect to one of a first electrical transmission component and a second electrical transmission component. A front end of the terminal extends out of the front opening and electrically contacts a mating terminal.

### BRIEF DESCRIPTION OF DRAWINGS

The invention will now be described by way of example with reference to the accompanying figures, of which:

FIG. 1 is a perspective view of an electrical connection module according to an exemplary embodiment;

FIG. 2 is a perspective view of an electrical connection between the electrical connection module of FIG. 1 and an electrical transmission component according to an exemplary embodiment;

FIG. 3 is a cross-sectional view of the electrical connection module of FIG. 1;

FIG. 4 is a partial exploded cross-sectional view of the electrical connection module of FIG. 1;

FIG. 5 is a partial exploded cross-sectional view of a terminal and a housing of the electrical connection module of FIG. 1;

FIG. 6 is a perspective rear side view of a connector according to an exemplary embodiment;

FIG. 7 is a front side perspective view of the connector of FIG. 6;

FIG. 8A is a partial front side exploded view of the connector of FIG. 6;

FIG. 8B is a perspective view of a front insulator and a ground terminal of the connector of FIG. 6;

FIG. 8C is an exploded view of the front insulator and the ground terminal of FIG. 8B;

FIG. 9 is a cross-sectional view of the connector of FIG. 6, where the front insulator and ground terminal of FIG. 8B are not shown;

FIG. 10 is a cross-sectional view of the connector of FIG. 6, where one electrical connection module of FIG. 1 is removed from an insulation housing of the connector;

FIG. 11 is a plan view of an electrical connection between the connector of FIG. 6, a mating connector, and the electrical transmission component of FIG. 2;

FIG. 12 is a perspective view of a connector according to another exemplary embodiment;

FIG. 13 is a perspective view of an electrical connection module according to another exemplary embodiment;

FIG. 14 is a perspective view of a connector according to another exemplary embodiment;

FIG. 15 is a perspective view of an electrical connection module according another exemplary embodiment;

FIG. 16 is a perspective view of the electrical connection module of FIG. 15, where a housing of the electrical connection module is not shown; and

FIG. 17 is a partial exploded view of the electrical connection module of FIG. 15.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

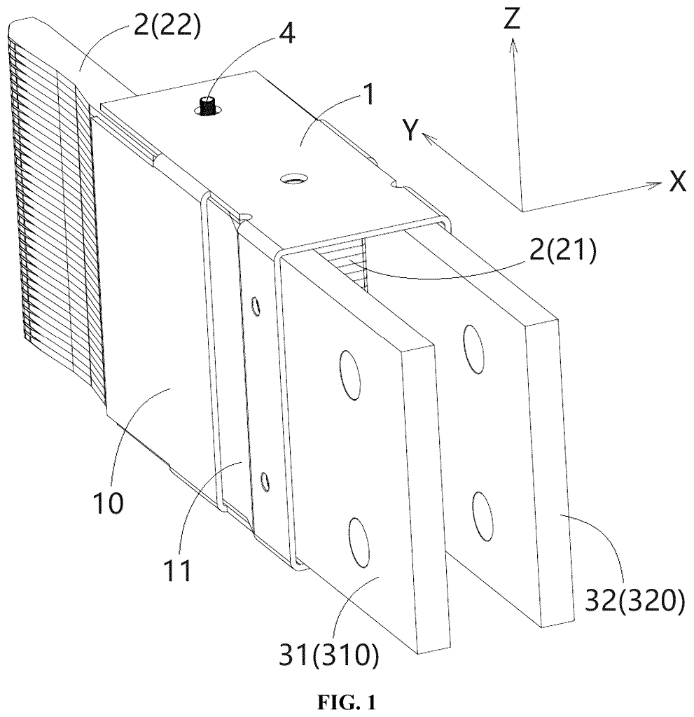

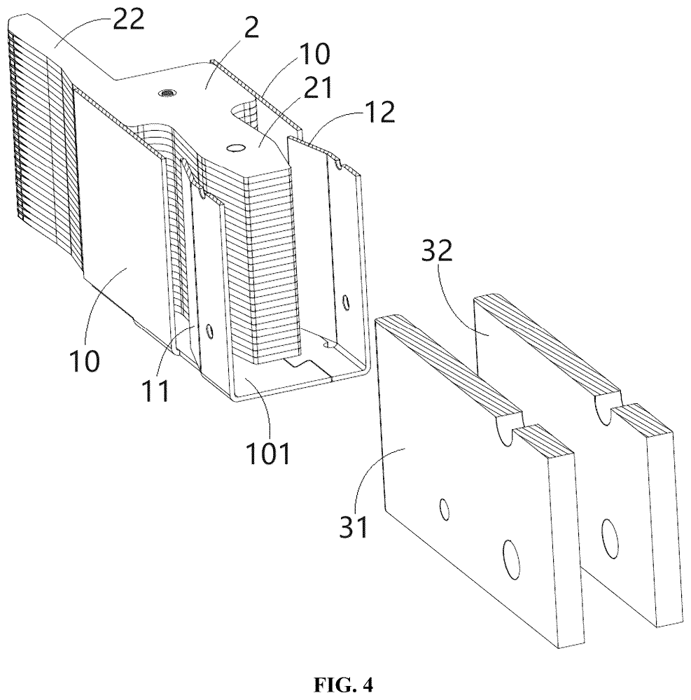

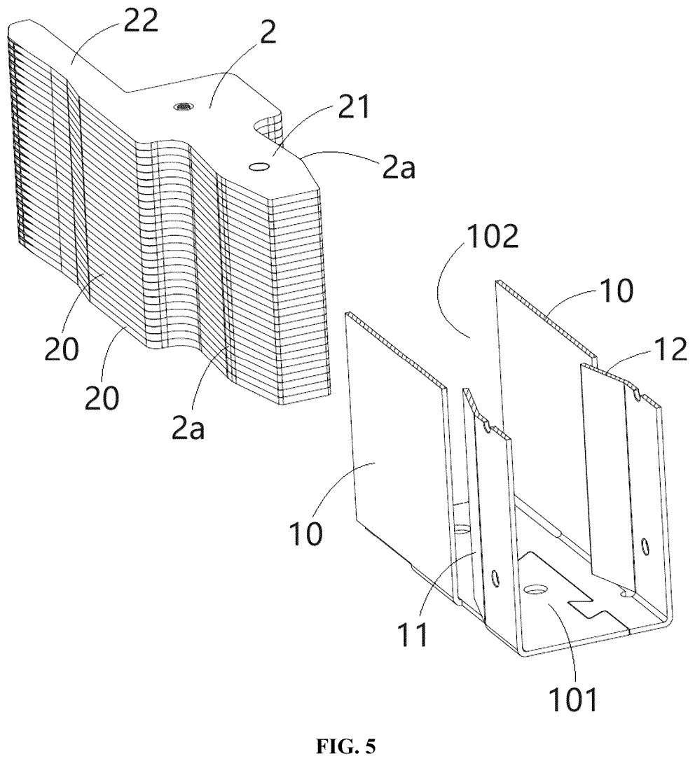

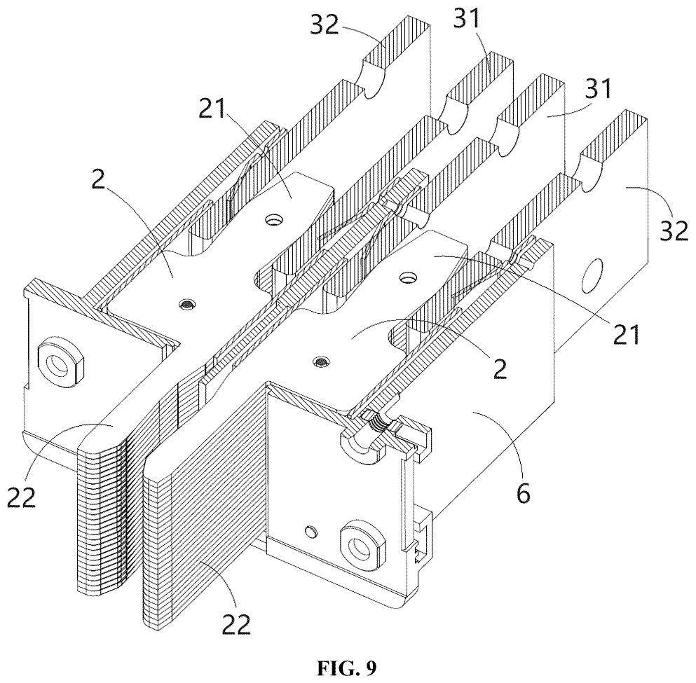

An exemplary embodiment of an electrical connection module is now described with reference to FIGS. 1-11. As shown in FIG. 1, the electrical connection module comprises a shell 1, a terminal 2, a first electrical connection member 31, and a second electrical connection member 32. As shown in FIG. 5, the shell 1 has a pair of side walls 10 opposite each other in the transverse direction X, a front opening 101 and a rear opening 102 opposite each other in the longitudinal direction Y, and a first spring piece 11 and a second spring piece 12 respectively formed on the pair of side walls 10. The terminal 2 is rotatably installed in the shell 1 and can swing relative to the shell 1 about an axis extending along the height direction Z of the shell 1. This allows the terminal 2 to swing around the support axis like a seesaw.

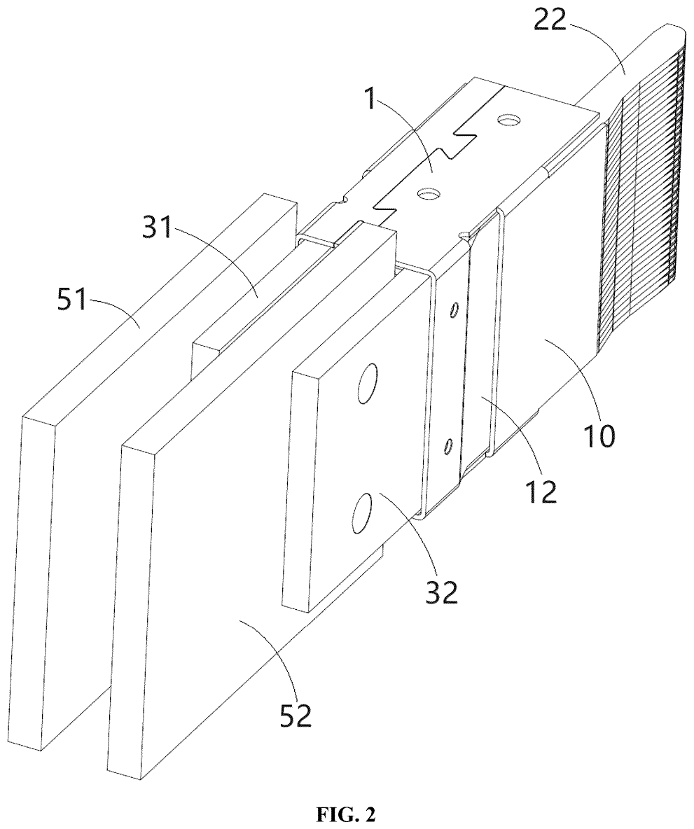

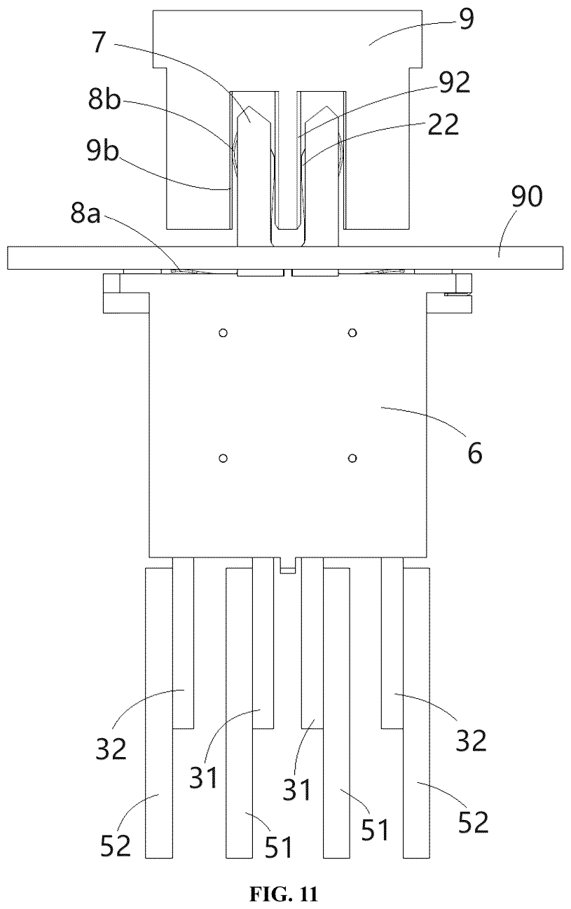

As shown in FIGS. 1 and 3-4, the first electrical connection member 31 has a first plate-shaped part 310, which is inserted into the rear opening 101 of the shell 1 and clamped between the first spring piece 11 and one side of the rear end portion 21 of the terminal 2 to make electrical contact with the terminal 2. As further shown in FIGS. 1 and 3-4, the second electrical connection member 32 has a second plate-shaped part 320, which is inserted into the rear opening 101 of the shell 1 and clamped between the second spring piece 12 and the other side of the rear end portion 21 of the terminal 2 to make electrical contact with the terminal 2. As shown in FIG. 2, a portion of the first electrical connection member 31 and a portion of the second electrical connection member 32 are located outside the shell 1, for electrical connection to the first electrical transmission component 51 and the second electrical transmission component 52, respectively. As shown in FIG. 11, the front end 22 of the terminal 2 extends out of the front opening 102 of the shell 1, for electrical contact with the mating terminal 92.

As shown in FIGS. 1-4, the front ends of the first plate-shaped part 310 and the second plate-shaped part 320 are inserted into the rear opening 101 of the shell 1, and the rear ends of the first plate-shaped part 310 and the second plate-shaped part 320 extend out of the rear opening 101 of the shell 1 for electrical connection to the first electrical transmission component 51 and the second electrical transmission component 52, respectively. The first plate-shaped part 310 and the second plate-shaped part 320 are perpendicular to the transverse direction X of the shell 1, and the rear ends of the first plate-shaped part 310 and the second plate-shaped part 320 are suitable for being welded to the first electrical transmission component 51 and the second electrical transmission component 52, respectively.

As shown in FIG. 5, the rear end portion 21 of the terminal 2 has contact protrusions 2a on both sides. The contact protrusions 2a on both sides of the rear end portion 21 of the terminal 2 are used to make electrical contact with the first plate-shaped part 310 and the second plate-shaped part 320, respectively.

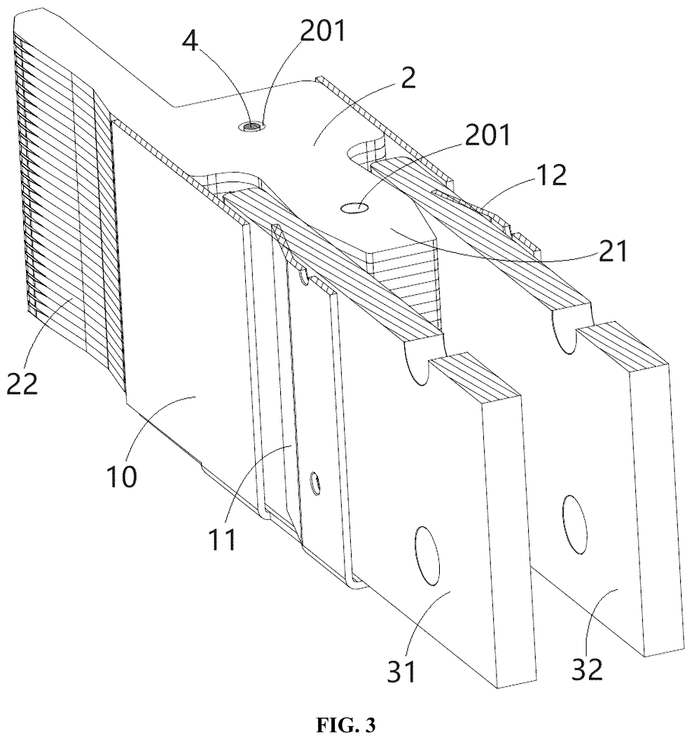

As shown in FIG. 3, a pin hole 201 penetrating the terminal 2 along the height direction Z of the shell 1 is formed in the terminal 2. The electrical connection module also includes a connection pin 4, as shown in FIGS. 1 and 3, passing through the pin hole 201. The two ends of the connection pin 4 pass through the top and bottom walls of the shell 1 and are respectively connected to the top and bottom walls of the shell 1, so that the terminal 2 can swing relative to the shell 1 about the axis of the connection pin 4.

As shown in FIG. 3, multiple pin holes 201 are formed in the terminal 2, and the multiple pin holes 201 are spaced apart in the longitudinal direction Y of the shell 1. The electrical connection module includes a single connection pin 4, as shown in FIGS. 1 and 3, which is suitable for being inserted into any of the multiple pin holes 201, so that the terminal 2 can swing around an axis at different positions to adjust the contact force between the terminal 2 and the first electrical connection member 31 and the second electrical connection members 32.

As shown in FIG. 5, the terminal 2 includes multiple terminal laminations 20 stacked in the height direction Z of the shell 1. As shown in FIG. 3, the pin hole 201 penetrates through the multiple terminal laminations 20 along the height direction Z of the shell 1. The multiple terminal laminations 20 are made of the same conductive material and are identical to each other for interchangeable use. The multiple terminal laminations 20 can be made of copper.

As shown in FIGS. 1-2, the shell 1 is an integral metal shell made by stamping a single metal sheet. For example, the shell 1 can be an integral steel shell made by stamping a steel plate.

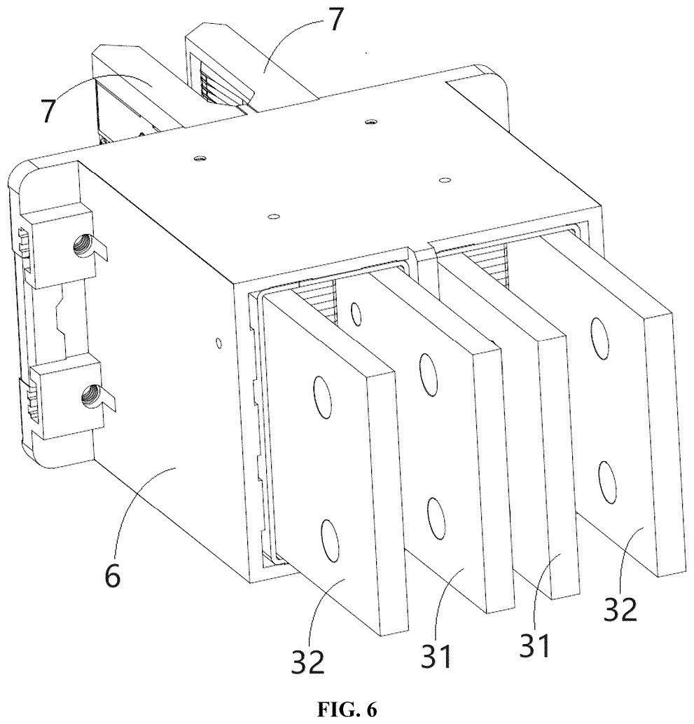

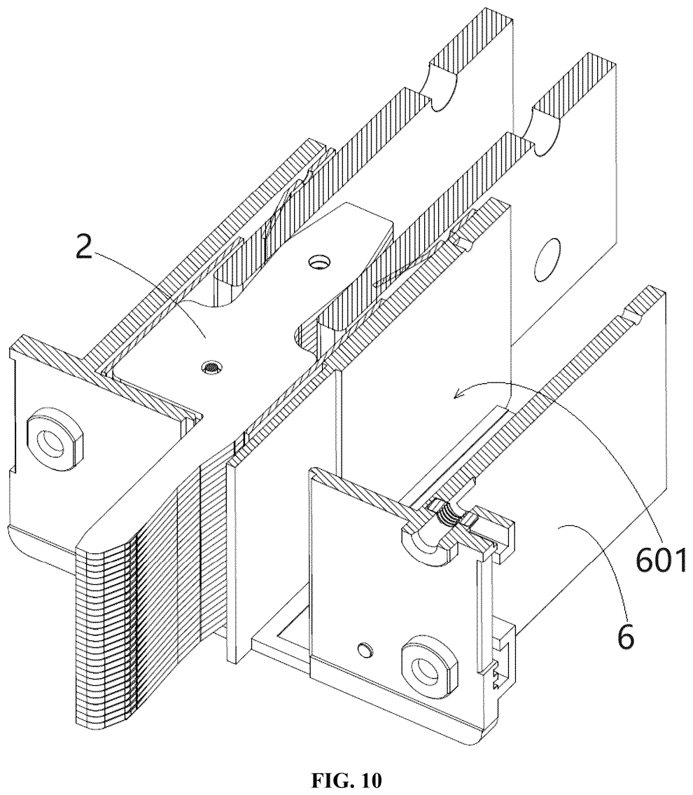

An exemplary embodiment of a connector is now described with reference to FIGS. 6-11. As shown in FIGS. 6-8A and 9-11, the connector comprises an insulation housing 6 and a pair of the aforementioned electrical connection modules according to FIGS. 1-11. As shown in FIG. 10, the insulation housing 6 is formed with two receiving chambers 601 arranged side by side in its transverse direction X. The pair of electrical connection modules are each installed separately into one of the two receiving chambers 601 of the insulation housing 6. As shown in FIG. 11, the first electrical connection member 31 and the second electrical connection member 32 of the electrical connection module extend out of the rear end of the insulation housing 6, for electrical connection to the first electrical transmission component 51 and the second electrical transmission component 52, respectively. As further shown in FIG. 11, the front end 22 of the terminal 2 of the electrical connection module extends out of the front end of the insulation housing 6, for electrical contact with the mating terminal 92 of the mating connector 9.

As shown in FIGS. 6-8A and 11, the connector further comprises a pair of front insulators 7 and a pair of ground terminals 8. The pair of front insulators 7 are respectively installed on the front end 22 of the pair of terminals 2 of the connector. The pair of front insulators 7 are connected to the insulation housing 6 through the pair of ground terminals 8. In this embodiment, the front insulator 7 can be moved together with the ground terminal 8, thereby increasing the contact force between the terminal 2 and the mating terminal 92 under the pushing force of the ground terminal 8.

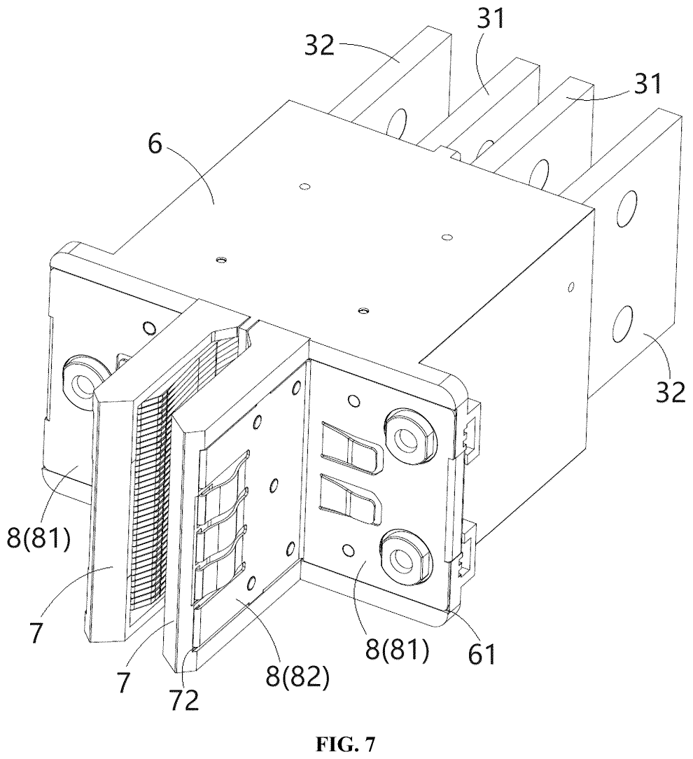

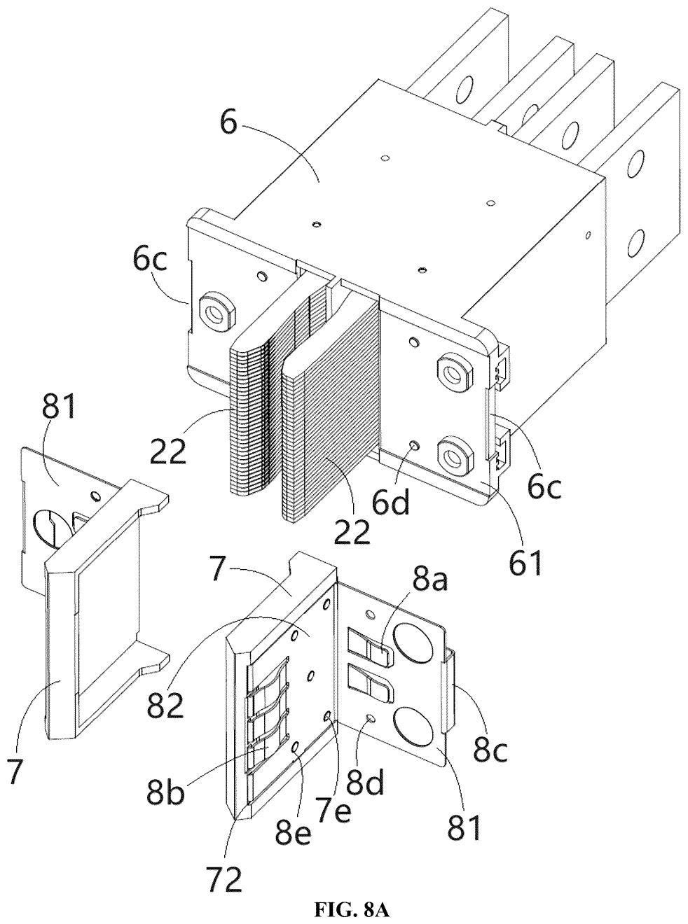

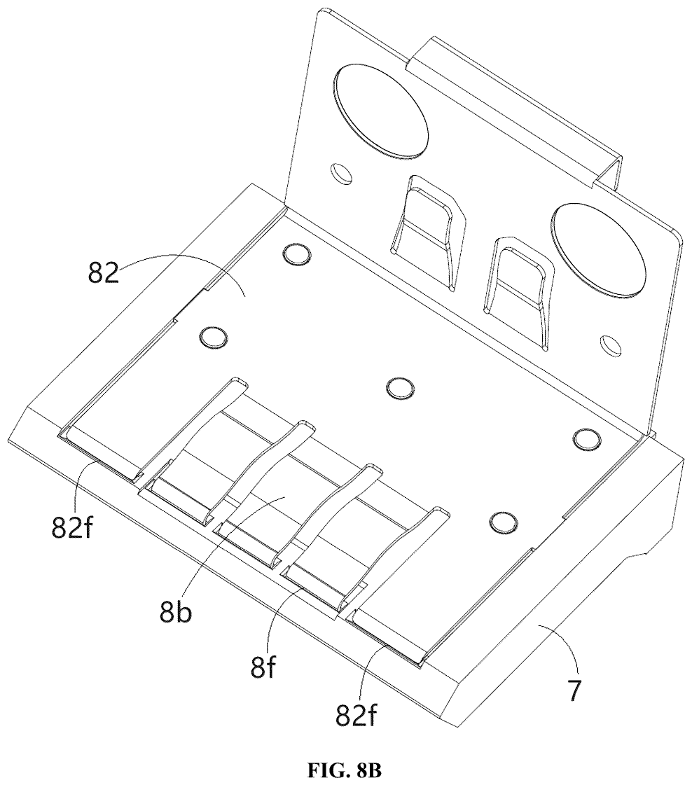

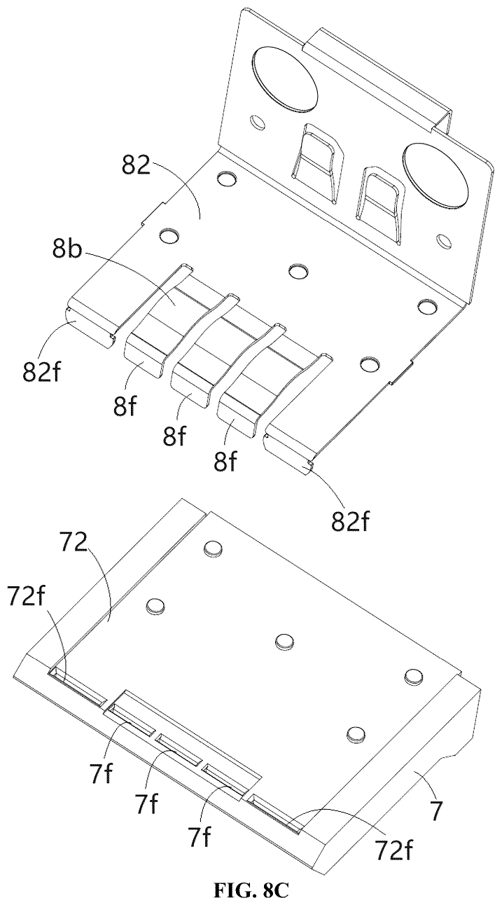

As shown in FIGS. 7-8A, the grounding terminal 8 includes a first mounting piece 81 and a second mounting piece 82. The first mounting piece 81 is perpendicular to the longitudinal direction Y of the insulation housing 6 and is mounted on the front end face of the insulation housing 6. The second mounting piece 82 is perpendicular to the transverse direction X of the insulation housing 6 and is mounted on the outer side of the front insulator 7. As shown in FIG. 7, the first mounting piece 81 and the second mounting piece 82 are perpendicularly connected, so that the grounding terminal 8 is L-shaped.

As shown in FIG. 7, a first recess 61 is formed on the front end face of the insulation housing 6, and the first mounting piece 81 is embedded in the first recess 61. A second recess 72, as shown in FIG. 7, is formed on the outer side of the front insulator 7, and the second mounting piece 82 is embedded in the second recess 72.

As shown in FIG. 8A, a first engagement protrusion 6d is formed on the front end surface of the insulation housing 6, and a first engagement hole 8d is formed in the first mounting piece 81, with the first engagement protrusion 6d being engaged into the first engagement hole 8d. As further shown in FIG. 8A, a second engagement protrusion 7e is formed on the outer side of the front insulator 7, and a second engagement hole 8e is formed in the second mounting piece 82. Each second engagement protrusion 7e is engaged into one second engagement hole 8e.

As shown in FIG. 8C, a first slot 6c is formed on the side of the front end of the insulation housing 6, and a first buckle 8c is formed on the side of the first mounting piece 81. The cross-section of the first buckle 8c, as shown in FIG. 8A, is C-shaped. The first buckle 8c is clamped in the first slot 6c on the side of the front end of the insulation housing 6.

As shown in FIG. 8A, a first contact spring 8a is formed on the first mounting piece 81 for electrical contact with the mounting panel 90, as shown in FIG. 11. A second contact spring 8b, as shown in FIGS. 8A-8C and 11, is formed on the second mounting piece 82. As shown in FIG. 11, the second contact spring 8b is used to make electrical contact with the mating ground terminal 9b of the mating connector 9.

As shown in FIGS. 8B-8C, second buckles 82f are formed on both sides of the front edge of the second mounting piece 82, and a second slot 72f corresponding to the second buckle 82f is formed on the front insulator 7. The second buckle 82f is inserted into the second slot 72f in an interference fit manner to fix the second mounting piece 82 to the front insulator 7.

As shown in FIGS. 8A and 8B, a leg 8f is formed at the end of the second contact spring 8b, and a slot 7f is formed in the front insulator 7. The leg 8f is inserted into the slot 7f and can move in the slot 7f when the second contact spring 8b is elastically deformed.

An exemplary embodiment of a connector assembly is now described with reference to FIG. 11. The connector assembly comprises the aforementioned connector according to FIGS. 6-11 and the mating connector 9. The mating connector 9 is mated with the connector. As shown in FIG. 11, the mating connector 9 includes two mating terminals 92 that are in electrical contact with the front ends 22 of the pair of terminals 2 of the connector, and two mating grounding terminals 9b that are in electrical contact with the pair of grounding terminals 8 of the connector.

As shown in FIG. 11, the connector assembly further includes a first electrical transmission component 51 and a second electrical transmission component 52. The first electrical transmission component 51 is electrically connected to the first electrical connection member 31 of the connector. The second electrical transmission component 52 is electrically connected to the second electrical connection member 32 of the connector. The first electrical transmission component 51 and the second electrical transmission component 52 are bus bars or wire bundles.

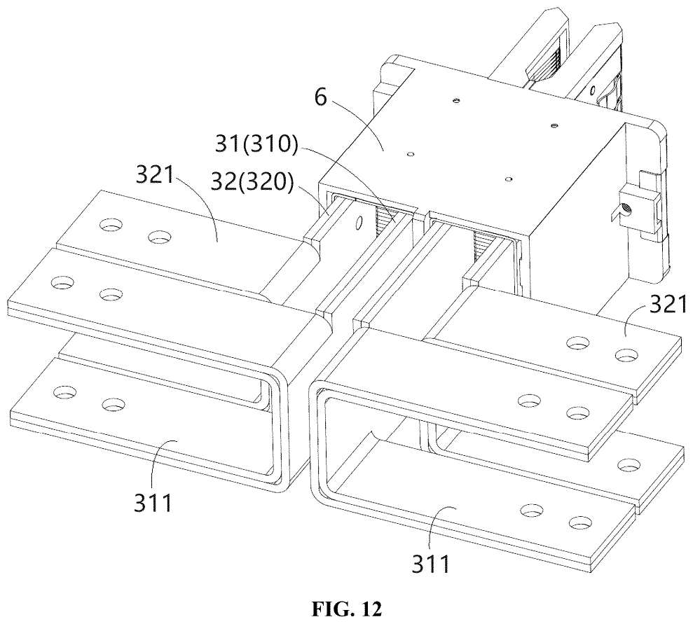

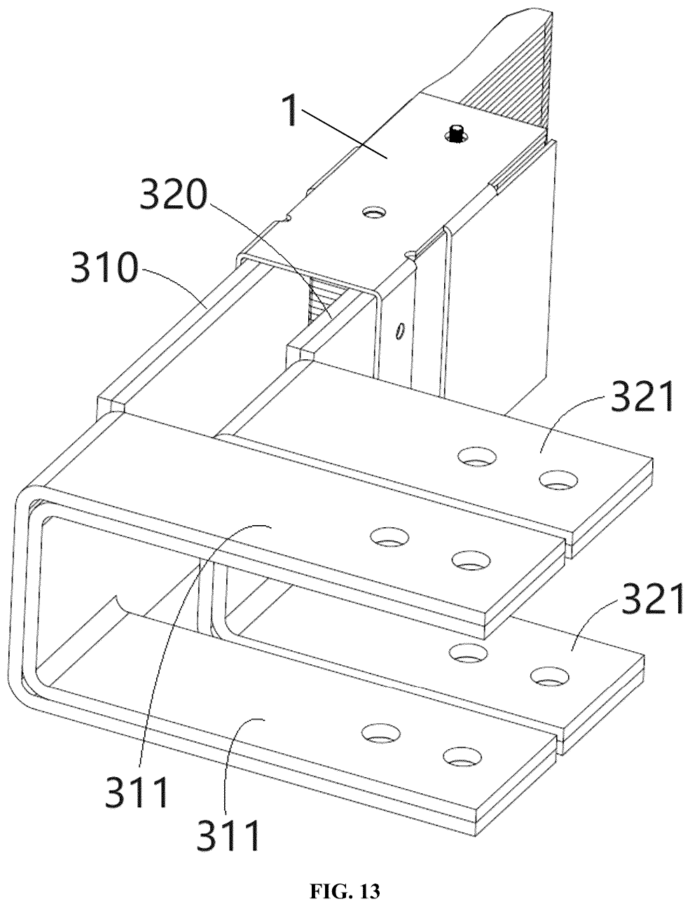

Another exemplary embodiment of a connector is now described with reference to FIGS. 12-13. The embodiment of the connector shown in FIGS. 12-13 differs from the embodiment of the connector shown in FIGS. 1-11 only in the structure of the first electrical connection member 31 and the second electrical connection member 32 of the electrical connection module.

In the embodiment of the connector shown in FIGS. 1-11, the first electrical connection member 31 only includes the first plate-shaped part 310, and the second electrical connection member 32 only includes a second plate-shaped part 320.

As shown in FIGS. 12-13, the embodiment of the connector shown in FIGS. 12-13 comprises the first electrical connection member 31 which has a first plate-shaped part 310 and a first side wing part 311. As further shown in FIGS. 12-13, the second electrical connection member 32 has a second plate-shaped part 320 and a second side wing part 321.

As shown in FIGS. 12-13, the rear end of the first plate-shaped part 310 extends out of the rear opening 101 of the shell 1, and the first side wing part 311 is plate-shaped and connected to one side of the rear end of the first plate-shaped part 310. The rear end of the second plate-shaped part 320 extends out of the rear opening 101 of the shell 1, and the second side wing part 321 is plate-shaped and connected to one side of the rear end of the second plate-shaped part 320. The first side wing part 311 and the second side wing part 321 are used to electrically connect to the first electrical transmission component 51 and the second electrical transmission component 52, respectively.

As shown in FIG. 13, the first plate-shaped part 310 and the second plate-shaped part 320 are perpendicular to the transverse direction X of the shell 1, and the first side wing part 311 and the second side wing part 321 are perpendicular to the height direction Z of the shell 1 and are suitable for being welded to the first electrical transmission component 51 and the second electrical transmission component 52, respectively.

As shown in FIG. 12, the first electrical connection member 31 has a multi-layer plate structure (such as a double-layer plate structure), and the outer layer plate of the first side wing part 311 is suitable for being welded to the first electrical transmission component 51 through ultrasonic welding technology. The second electrical connection member 32 has a multi-layer plate structure (such as a double-layer plate structure), and the outer layer plate of the second side wing 321 is suitable for being welded to the second electrical transmission component 52 through ultrasonic welding technology. This can reduce the power of the ultrasonic welding machine and lower the difficulty of welding.

As shown in FIG. 13, the first plate-shaped part 310 extends backwards along the longitudinal direction Y of the shell 1 beyond the second plate-shaped part 320. The first side wing part 311 and the second side wing part 321 are spaced apart in the longitudinal direction Y of the shell 1 and extend in the same direction along the transverse direction X of the shell 1.

As shown in FIGS. 12-13, the first electrical connection member 31 has a pair of first side wing parts 311, which are respectively connected to the upper and lower side edges of the rear end of the first plate-shaped part 310. The second electrical connection member 32 has a pair of second side wing parts 321, which are respectively connected to the upper and lower side edges of the rear end of the second plate-shaped part 320.

Except for the above differences, other technical features of the embodiment of the connector shown in FIGS. 12-13 are basically the same as those of embodiment of the connector shown in FIGS. 1-11.

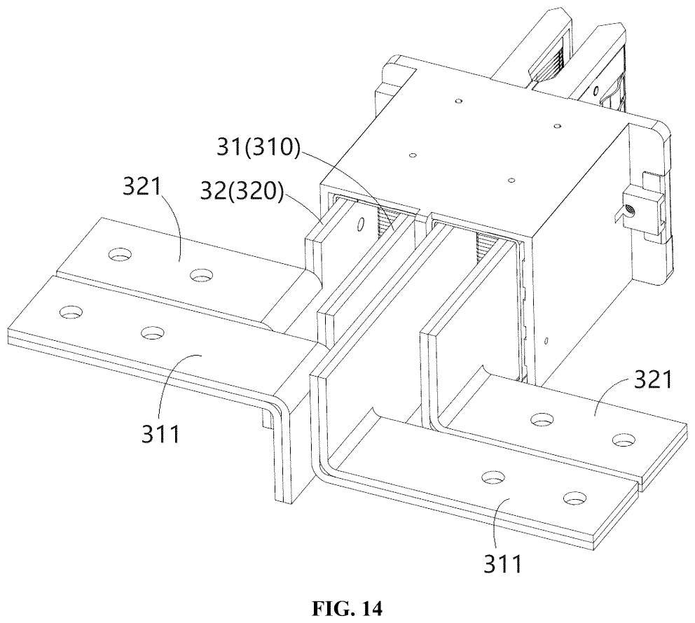

Another exemplary embodiment of a connector is now described with reference to FIG. 14. The only difference between the embodiment of the connector shown in FIG. 14 and the embodiment of the connector shown in FIGS. 12-13 is the structure of the first electrical connection member 31 and the second electrical connection member 32.

In the embodiment of the connector shown in FIGS. 12-13, the first electrical connection member 31 has a pair of first side wings 311, and the second electrical connection member 32 has a pair of second side wings 321.

As shown in FIG. 14, the embodiment of the connector shown in FIG. 14 comprises the first electrical connection member 31 which has a single first side wing part 311, which is connected to the upper or lower side edge of the rear end of the first plate-shaped part 310. As further shown in FIG. 14, the second electrical connection member 32 has a single second side wing part 321, which is connected to the upper or lower side edge of the rear end of the second plate-shaped part 320.

Except for the differences mentioned above, the other technical features of the embodiment of the connector shown in FIG. 14 are basically the same as those of the embodiment of the connector shown in FIGS. 12-13.

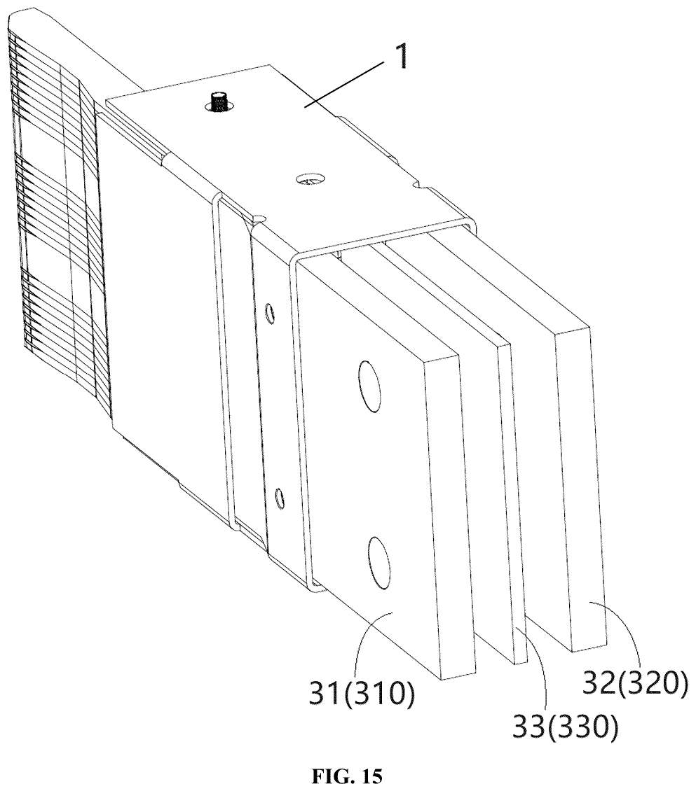

Another exemplary embodiment of a connector is now described with reference to FIGS. 15-17. The difference between the embodiment of the connector shown in FIGS. 15-17 and the embodiment of the connector shown in FIGS. 1-11 lies in the structure of the terminal 2 and the addition of a third electrical connection member 33.

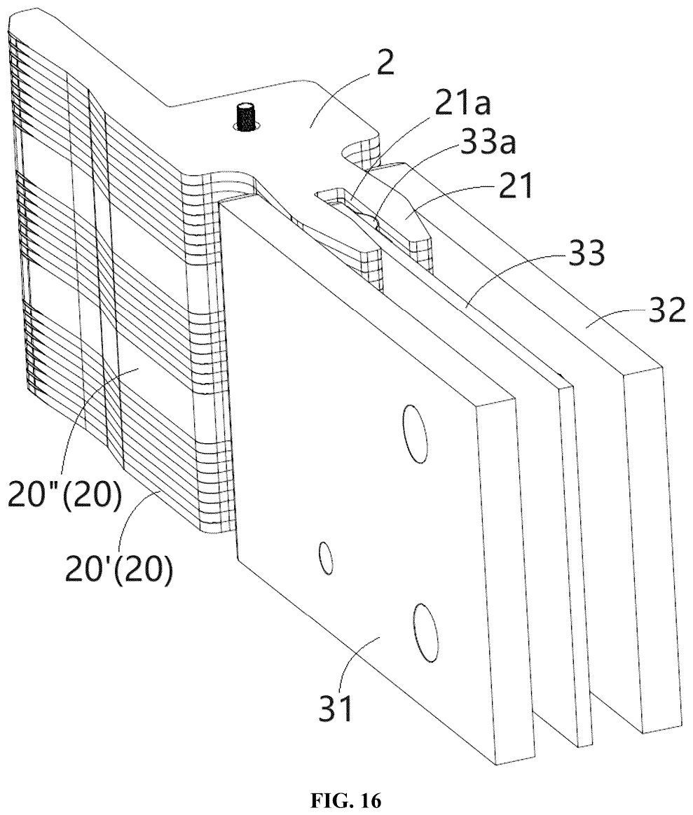

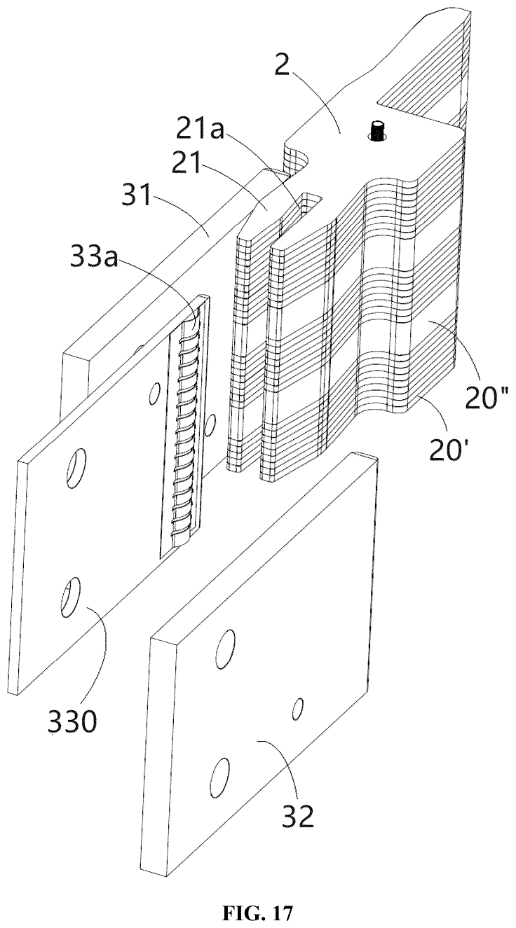

As shown in FIGS. 16-17, the terminal 2 has multiple terminal laminations 20. The multiple terminal laminations 20 include a first terminal lamination 20′ and a second terminal lamination 20″. The first terminal lamination 20′ is made of a first conductive material, such as copper. The second terminal lamination 20″ is made of a second conductive or non-conductive material, such as aluminum or plastic.

The conductivity of the first conductive material is superior to that of the second conductive material, so that the conductivity of the terminal 2 can be adjusted by changing the number of first terminal laminations 20′ and second terminal laminations 20″ without changing the total thickness of the multiple terminal laminations 20 (i.e. the thickness of the terminal 2).

As shown in FIGS. 16-17, the thickness of the second terminal lamination 20″ is equal to an integer multiple of the thickness of the first terminal lamination 20′. This makes it easier to replace and adjust the quantity of the first terminal lamination 20′ and the second terminal lamination 20″.

As shown in FIGS. 15-17, the electrical connection module further includes a third electrical connection member 33 and an elastic contact piece 33a. As shown in FIG. 15, the third electrical connection member 33 includes a third plate-shaped part 330. The elastic contact piece 33a, as shown in FIGS. 16-17, is fixed to one side of the front end of the third plate-shaped part 330. As shown in FIGS. 16-17, on the rear end portion 21 of the terminal 2, there is a slot 21a extending along the height direction Z and longitudinal direction Y of the shell 1. As shown in FIG. 16, the front end of the third plate-shaped part 330 and the elastic contact piece 33a are inserted into the slot 21a. The front end of the third plate-shaped part 330 is in electrical contact with the terminal 2 through the elastic contact piece 33a, and a part of the third electrical connection member 33 is located outside the shell 1 for electrical connection to a third electrical transmission component.

As shown in FIG. 15, the third plate-shaped part 330 is perpendicular to the transverse direction X of the shell 1, and the rear end of the third plate-shaped part 330 extends out of the rear opening 101 of the shell 1 and is suitable for welding to the third electrical transmission component.

In another embodiment of the present invention, the rear end of the third plate-shaped part 330 extends out of the rear opening 101 of the shell 1, and the third electrical connection member 33 also has a plate-shaped third side wing part, which is connected to one side of the rear end of the third plate-shaped part 330 and used for electrical connection to the third electrical transmission component.

Another embodiment of a connector assembly is now described. The connector assembly further comprises a third electrical transmission component, which is electrically connected to the third electrical connection member 33 of a connector comprising the embodiment of the connector shown in FIGS. 15-17. The third electrical transmission component can be a busbar or a bundle of wires.

In the aforementioned exemplary embodiments according to the present invention, the rear end of each terminal 2 is in electrical contact with multiple electrical connection members 31,32 or 31,32,33 simultaneously. Therefore, each terminal 2 can be electrically connected to multiple electrical transmission components simultaneously, expanding the application range of the connector and improving the current carrying capacity of the connector, increasing the heat dissipation area of the terminals 2 of the connector, and reducing the temperature rise of the terminals 2 of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. An electrical connection module, comprising:
a shell having a pair of side walls opposite each other in a transverse direction of the shell, a front opening and a rear opening opposite each other in a longitudinal direction of the shell, and a first spring piece and a second spring piece each formed on one side wall;
a terminal having a rear end portion and rotatably installed in the shell and swinging relative to the shell about an axis extending along a height direction of the shell;
a first electrical connection member having a first plate-shaped part inserted into the rear opening and clamped between the first spring piece and one side of the rear end portion making electrical contact with the terminal; and
a second electrical connection member having a second plate-shaped part inserted into the rear opening and clamped between the second spring piece and the other side of the rear end portion making electrical contact with the terminal, a portion of the first electrical connection member and a portion of the second electrical connection member are located outside the shell and each electrically connect to one of a first electrical transmission component and a second electrical transmission component, a front end of the terminal extends out of the front opening and electrically contacts a mating terminal.

2. The electrical connection module of claim 1, wherein a front end of the first plate-shaped part and a front end of the second plate-shaped part are each inserted into the rear opening, and a rear end of the first plate-shaped part and a rear end of the second plate-shaped part each extend out of the rear opening and electrically connect to one of the first electrical transmission component and the second electrical transmission component, the first plate-shaped part and the second plate-shaped part are perpendicular to the transverse direction, and the rear end of the first plate-shaped part and the rear end of the second plate-shaped part are each welded to one of the first electrical transmission component and the second electrical transmission component.

3. The electrical connection module of claim 1, wherein a rear end of the first plate-shaped part extends out of the rear opening, the first electrical connection member has a plate-shaped first side wing part connected to one side of the rear end of the first plate-shaped part, a rear end of the second plate-shaped part extends out of the rear opening, and the second electrical connection member has a plate-shaped second side wing part connected to one side of the rear end of the second plate-shaped part, the plate-shaped first side wing part and the plate-shaped second side wing part each electrically connect to one of the first electrical transmission component and the second electrical transmission component.

4. The electrical connection module of claim 3, wherein the first plate-shaped part and the second plate-shaped part are perpendicular to the transverse direction, the plate-shaped first side wing part and the plate-shaped second side wing part are perpendicular to the height direction and are welded to one of the first electrical transmission component and the second electrical transmission component.

5. The electrical connection module of claim 4, wherein the first electrical connection member has a multi-layer plate structure, an outer layer plate of the plate-shaped first side wing part is welded to the first electrical transmission component with ultrasonic welding, the second electrical connection member has a multi-layer plate structure, and an outer layer plate of the plate-shaped second side wing part is welded to the second electrical transmission component with ultrasonic welding.

6. The electrical connection module of claim 5, wherein the first electrical connection member has a single plate-shaped first side wing part connected to an upper side edge or a lower side edge of the rear end of the first plate-shaped part, and the second electrical connection member has a single plate-shaped second side wing part connected to an upper side edge or a lower side edge of the rear end of the second plate-shaped part.

7. The electrical connection module of claim 5, wherein the first electrical connection member has a pair of plate-shaped first side wings connected to an upper side edge and a lower side edge of the rear end of the first plate-shaped part, and the second electrical connection member has a pair of plate-shaped second side wings connected to an upper side edge and a lower side edge of the rear end of the second plate-shaped part.

8. The electrical connection module of claim 1, wherein both sides of the rear end portion each have contact protrusions, each contact protrusion electrically contacts one of the first plate-shaped part and the second plate-shaped part.

9. The electrical connection module of claim 1, wherein a pin hole formed in the terminal penetrates the terminal along the height direction, the electrical connection module has a connection pin passing through the pin hole, two ends of the connection pin each pass through one of a top wall and a bottom wall of the shell and are each connected to one of the top wall and the bottom wall and allow the terminal to swing relative to the shell around an axis of the connection pin.

10. The electrical connection module of claim 9, wherein a plurality of pin holes formed in the terminal are spaced apart in the longitudinal direction, the electrical connection module has a single connection pin insertable into any one of the plurality of pin holes allowing the terminal to swing around an axis at different positions to adjust a contact force between the terminal and the first electrical connection member and the second electrical connection member.

11. The electrical connection module of claim 9, wherein the terminal has a plurality of terminal laminations stacked in the height direction, each pin hole penetrates the plurality of terminal laminations along the height direction.

12. The electrical connection module of claim 11, wherein the plurality of terminal laminations are each made of the same conductive material and are identical to each other.

13. The electrical connection module of claim 11, wherein the plurality of terminal laminations include a first terminal lamination made of a first conductive material, and a second terminal lamination made of a second conductive material or a non-conductive material, a conductivity of the first conductive material is superior to that of the second conductive material, a conductivity of the terminal is adjustable by changing a number of the first terminal lamination and the second terminal lamination without changing a thickness of the terminal.

14. The electrical connection module of claim 1, wherein the shell is an integral metal shell stamped out of a single metal sheet.

15. The electrical connection module of claim 1, further comprising a third electrical connection member having a third plate-shaped part, and an elastic contact piece fixed to one side of the front end of the third plate-shaped part, a slot extending along the height direction and the longitudinal direction is formed in the rear end portion, a front end portion of the third plate-shaped part and the elastic contact piece are inserted into the slot, the front end portion of the third plate-shaped part electrically contacts the terminal through the elastic contact piece, a part of the third electrical connection member is located outside the shell and electrically connects to a third electrical transmission component.

16. A connector, comprising:
an insulation housing formed with two receiving chambers arranged side by side in a transverse direction of the connector; and
a pair of electrical connection modules each installed in one receiving chamber, each electrical connection model includes a shell, a terminal, a first electrical connection member, and a second electrical connection member, the shell has a pair of side walls opposite each other in a transverse direction of the shell, a front opening and a rear opening opposite each other in a longitudinal direction of the shell, and a first spring piece and a second spring piece each formed on one side wall, the terminal has a rear end portion, is rotatably installed in the shell, and swings relative to the shell about an axis extending along a height direction of the shell, the first electrical connection member has a first plate-shaped part inserted into the rear opening and clamped between the first spring piece and one side of the rear end portion making electrical contact with the terminal, and the second electrical connection member has a second plate-shaped part inserted into the rear opening and clamped between the second spring piece and the other side of the rear end portion making electrical contact with the terminal, the first electrical connection member and the second electrical connection member each extend out of a rear end of the insulation housing and electrically connect to one of a first electrical transmission component and a second electrical transmission component, a front end of the terminal extends out of a front end of the insulation housing and electrically contacts with a mating terminal of a mating connector.

17. The connector of claim 16, further comprising a pair of front insulators each installed on one terminal of the connector, and a pair of ground terminals, the pair of front insulators are each connected to the insulation housing through the pair of ground terminals.

18. The connector of claim 17, wherein each grounding terminal has a first mounting piece perpendicular to the longitudinal direction of the insulation housing and mounted on a front end face of the insulation housing, and a second mounting piece perpendicular to the transverse direction of the insulation housing and mounted on an outer side of one front insulator, the first mounting piece and the second mounting piece are perpendicularly connected, the grounding terminal has an L-shape.

19. The connector of claim 18, wherein a first contact spring formed on the first mounting piece electrically contacts a mounting panel, and a second contact spring formed on the second mounting piece electrically contacts a mating ground terminal of the mating connector.

20. A connector assembly, comprising:
a connector including an insulation housing and a pair of electrical connection modules, the insulation housing is formed with two receiving chambers arranged side by side in a transverse direction of the connector, and the pair of electrical connection modules are each installed in one receiving chamber, each electrical connection model includes a shell, a terminal, a first electrical connection member, and a second electrical connection member, the shell has a pair of side walls opposite each other in a transverse direction of the shell, a front opening and a rear opening opposite each other in a longitudinal direction of the shell, and a first spring piece and a second spring piece each formed on one side wall, the terminal has a rear end portion, is rotatably installed in the shell, and swings relative to the shell about an axis extending along a height direction of the shell, the first electrical connection member has a first plate-shaped part inserted into the rear opening and clamped between the first spring piece and one side of the rear end portion making electrical contact with the terminal, and the second electrical connection member has a second plate-shaped part inserted into the rear opening and clamped between the second spring piece and the other side of the rear end portion making electrical contact with the terminal, the first electrical connection member and the second electrical connection member each extend out of a rear end of the insulation housing, a front end of the terminal extends out of a front end of the insulation housing;
a mating connector mated with the connector;
a first electrical transmission component electrically connected to the first electrical connection member; and
a second electrical transmission component electrically connected to the second electrical connection member, the mating connector has two mating terminals each electrically contacting one front end of one terminal of the connector, and two mating grounding terminals each electrically contacting one of a pair of grounding terminals of the connector.
